(19) United States
(12) Patent Application Publication
(10) Pub. No.: US 2010/0024798 A1
(43) Pub. Date: Feb. 4, 2010

(54) BARBECUE

(76) Inventor: Grant Sampson, Queensland (AU)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 12/514,529

(22) PCT Filed: Nov. 6, 2007
(86) PCT No.: PCT/AU07/01694

§ 371 Date: May 12, 2009

(51) Int. Cl. A47J 37/07

(52) U.S. Cl. 126/25 R; 126/9 B

(57) ABSTRACT

A barbecue in the form of a box that is closed except at the top. Burning material and ash from the burning material is contained completely within the barbecue to protect the environment. Plates rest on a ledge at the top of the box and are slidable to regulate air flow. A lid or lids close the firebox to avoid spreading dust during transport. The base and walls of the firebox may be filled with insulating material. The firebox may be configured as a barbecue, an open fire or a rotisserie.

The invention relates to a barbecue or firebox. In particular it relates to a barbecue or firebox that does not drop ash.

### BACKGROUND TO THE INVENTION

An open fire holds a certain fascination for man. Almost everybody finds it enjoyable to sit around an open fire. It is also very enjoyable to cook on an open fire. The food has a distinctive and satisfying flavour when cooked over flames. In Australia it is also very popular social pastime to cook on an outdoor barbecue, which in many ways approximates an open fire.

Most barbecues and open fires are fixed installations of brick and mortar. Very few barbecues and open fires can be transported to another location. This is unfortunate since it is fun to have an open fire when camping or meeting friends at a park. In the past it has been allowable to build a fire on the ground in parks and campsites but this is seriously restricted in most places these days. Even the dropping of ash is prohibited in many places.

Those barbecues that can be transported generally use gas as the fuel source or use fuel beads that drop ash through a vent in the bottom of the barbecue. Neither option is very versatile, and the fuel bead barbecues are not suitable if dropping of ash is a problem. There is also a significant problem with mess in the vehicle transporting the barbecue, which is normally the family car.

Other types of barbecues known as kettles address some of the issues of mess but negate the open fire feel.

### OBJECT OF THE INVENTION

It is an object of the present invention to provide a barbecue or fire box that safely provides an open fire feel.

Further objects will be evident from the following description.

### DISCLOSURE OF THE INVENTION

In one form, although it need not be the only or indeed the broadest form, the invention resides in a barbecue comprising: a base and four walls forming a box with an open top, the four walls forming a ledge around the open top;

at least one plate movable on the ledge to regulate a space between the plate and at least one wall; and

an air flow path through the space and under the plate to provide air to a burning material in the box.

Suitably the barbecue further comprises at least one lid that closes the open top to contain ash within the firebox.

The base and walls are preferably filled with heat insulating material.

There may usefully be a perforated grate in the bottom of the box for supporting the burning material in the bottom of the box. It is useful for the perforated grate to be spaced from the base on feet.

### BRIEF DETAILS OF THE DRAWINGS

To assist in understanding the invention preferred embodiments will now be described with reference to the following figures in which:

FIG. 1 is a sketch of a barbecue;

FIG. 2 is cross-sectional side view of the barbecue of FIG. 1;

FIG. 3 is a sketch of the barbecue of FIG. 1 when closed and prepared transport;

FIG. 4 is a sketch of a second embodiment of a barbecue;

FIG. 5 is a sketch of the barbecue of FIG. 1 configured as a fire box;

FIG. 6 is a cross-sectional side view of the fire box of FIG. 5; and

FIG. 7 is a sketch of a rotisserie barbecue.

### DETAILED DESCRIPTION OF THE DRAWINGS

In describing different embodiments of the present invention common reference numerals are used to describe like features.

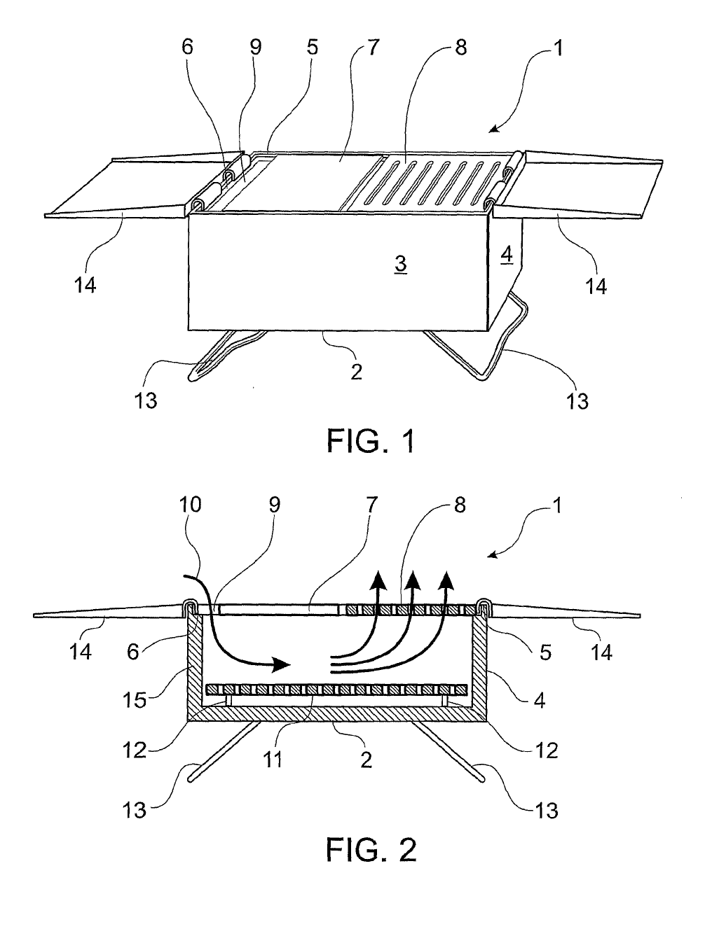

Referring to FIG. 1, there is shown a sketch of one embodiment of a barbecue generally designated as 1. The barbecue 1 consists of a base 2, a pair of opposing long walls 3 and a pair of opposing short walls 4. The base and four walls form an open-topped box. Although the embodiment shown in FIG. 1 is rectangular there is no particular reason for this configuration, although it does provide a convenient shape for a barbecue plate.

Each wall 3, 4 terminates in a lip 5 which leaves a ledge 6 around the top of the barbecue 1. In the preferred embodiment of FIG. 1 the ledge is about 30 mm, but there is no particular reason for this specific dimension. A solid plate 7 and grille plate 8 are positioned on the ledge 6. The plates are able to slide on the ledge to open a space 9 adjacent one of the walls. The plates 7, 8 are slid to regulate the size of the space 9 and thus regulate the flow of air through the barbecue 1 as depicted by the arrows 10 in FIG. 2. The solid plate 7 and grille plate 8 are preferably made from cast iron so as to absorb and hold heat for cooking. The size of the plates 7,8 is chosen so that the plates cover the space defined by the ledge. It will be understood therefore that sliding the plates to one side will open a space the size of the ledge. The inventor has found that this is a good size for regulation of air flow.

Although a solid plate and a grille plate are shown in FIG. 1 and FIG. 2, the invention is not limited to this configuration. Nonetheless, the inventor has found this to be a particular effective arrangement.

In use a fire is built with burning material placed in the bottom of the box. Air flows through the space 9 to feed the burning material and generate heat for cooking on the plates 7, 8. As shown in FIG. 2, heat and hot gases rise through the grille plate 8. A low pressure region is produced by the rising hot gases which produces an air flow as shown by the arrows. The barbecue completely contains all ash resulting from the burning material and is therefore completely friendly to the environment. To assist airflow around the burning material a grate 11 can be positioned in the bottom of the barbecue 1. The grate 11 has feet 12 that space the grate from the bottom of the barbecue.

A pair of folding legs 13 support the barbecue at a convenient height from the ground. The legs 13 are completely optional and may be removed or discarded however the legs prevent any damage to the ground due to heat from the barbecue.

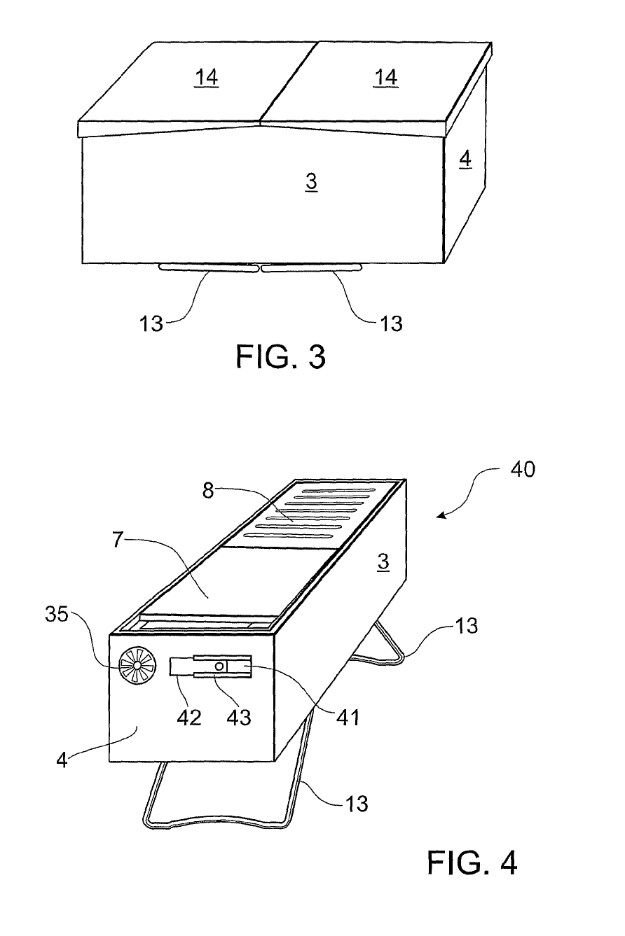

The barbecue 1 may be closed by a pair of lids 14, as shown in FIG. 3. Although a pair of lids are convenient a single lid is also suitable. It is convenient if a lid 14 can hook on a lip 5 of the barbecue 1 to provide a shelf, as shown in FIG. 1 and FIG. 2. The lids can be used to snuff the fire when cooking is complete. Closing the lids as shown in FIG. 3 stops air flow which starves the fire till it goes out. As mentioned above, the fire can also be starved of oxygen by positioning the plates to cover the opening between the ledges.

The barbecue 1 is preferably made from folded stainless steel, although other materials, such as heat treated aluminum alloy or steel will also be suitable. A gap 15 between an inner and outer skin of each wall provides a degree of insulation to limit heat transfer. The gap 15 may be filled with an insulating material, such as Kaowool. The insulating material limits the transfer of heat so that the barbecue is safe around animals and children. It can also be packed up and transported quickly with minimal cool down time.

Air flow may also be regulated by a closable vent formed in a side of the barbecue. An embodiment of a barbecue 40 showing two forms of vent of closable vent is shown in FIG. 4. One form of vent 41 comprises a plate 42 that slides in a track 43. The vent 41 is an aperture through the wall 4 that may be completely closed by the plate 42 or partially opened to allow air flow. Another form of vent is a rotating vane 55. The vanes 55 may be rotated to uncover an aperture through the wall 44. It will be appreciated that two forms of vent are shown for convenience and it is unlikely that both forms would be provided on the same firebox or barbecue.

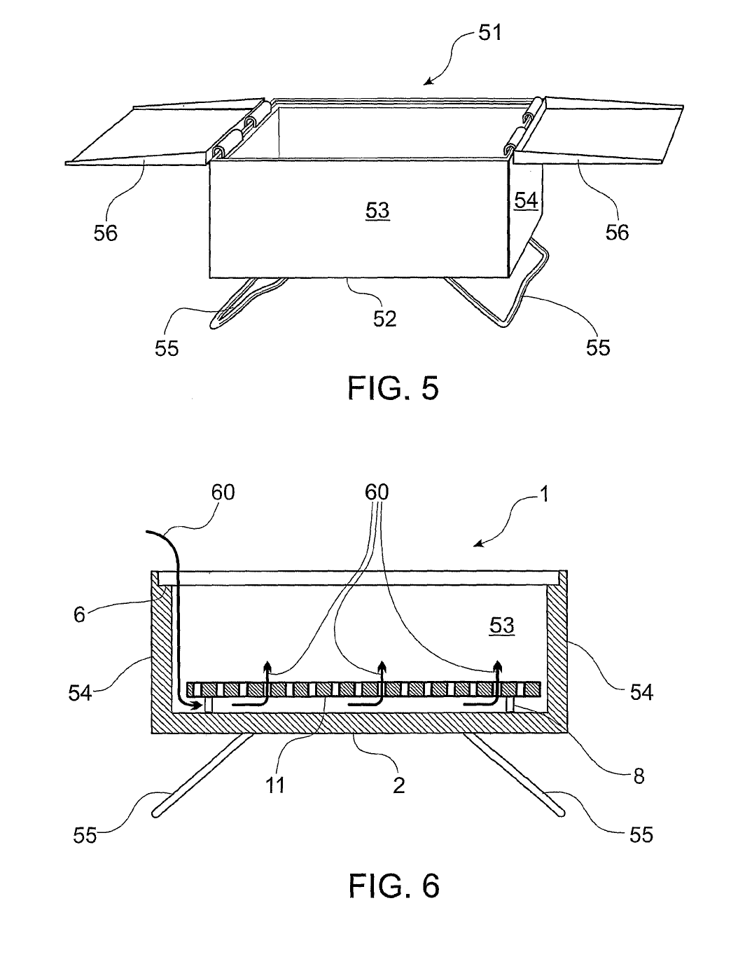

The barbecue can easily be configured as a firebox 51, as shown in of FIG. 5. The barbecue 51 consists of a base 52, a pair of opposing long walls 53 and a pair of opposing short walls 54. A pair of folding legs 55 support the firebox at a convenient height of the ground. It is convenient if a lid 56 can hook on a side 54 of the barbecue 51 to provide a shelf (as shown). The barbecue 51 may also be closed by a pair of lids 56. A grille 57 has feet 58 to space the fire material from the base 52 and apertures 59 to allow airflow as shown by arrows 60, as seen most clearly in FIG. 6. The base 2 and walls 3,4 suitably have a gap 61 that may be filled with insulating material.

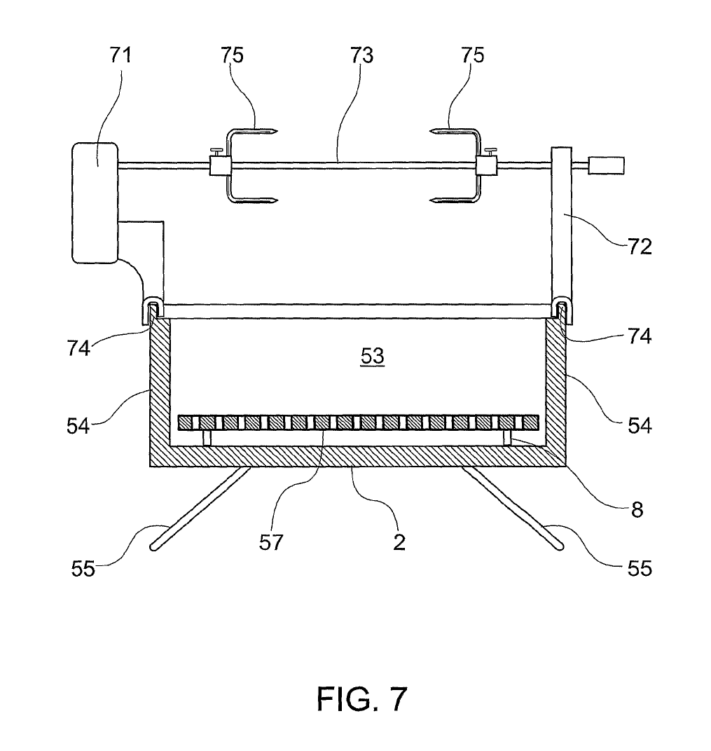

The firebox of FIG. 5 may also be configured for rotisserie cooking as shown in FIG. 7. A motor 71 fits onto the lip 74 at the top of wall 54. A corresponding support 72 fits on the opposing lip 74. A rod 73 extends from the motor 71 to the support 72 and is rotated by the motor 71. Food is placed on the rod 73 and held by skewers 75 to be cooked on a fire burning on grille 57.

A particular advantage of the barbecue 1 and firebox 51 is that it can be easily transported after use without spreading ash. As seen in FIG. 3, the lids 14 are used to close the barbecue 1 to prevent ash blowing out during transport. Furthermore, the barbecue is environmentally friendly as it does not drop ash during use nor scorch the ground beneath (when the legs are used). There is no risk of starting a bushfire with the barbecue 1. However, the particular attraction and versatility of an open fire is maintained and there is no risk of running out of gas.

With the legs folded and the lid closed the firebox is a lightweight rectangular box that is easily lifted and carted. The insulated walls reduce the transfer of heat from the internal fire to the outer walls, thus minimizing the waiting time before the firebox can be touched.

Throughout the specification the aim has been to describe the preferred embodiments of the invention without limiting the invention to any one embodiment or specific collection of features. Persons skilled in the relevant art may readily conceive of simple variations, such as external handles to the firebox.

1. A barbecue comprising:
a base and four walls forming a box with an open top, the four walls forming a ledge around the open top;
at least one plate movable on the ledge to regulate a space between the plate and at least one wall;
an air flow path through the space and under the plate to provide air to a burning material in the box.

2. The barbecue of claim 1 further comprising at least one lid that closes the open top to contain ash within the firebox.

3. The barbecue of claim 2 wherein the lid is adapted to hook onto a lip of a wall.

4. The barbecue of claim 2 wherein the lid is adapted to hook onto a lip of a wall to form a shelf.

5. The barbecue of claim 1 wherein the base and walls are formed from an inner skin and an outer skin defining a gap therebetween.

6. The barbecue of claim 5 wherein the gap is filled with heat insulating material.

7. The barbecue of claim 1 further comprising a perforated grate in the bottom of the box for supporting burning material.

8. The barbecue of claim 7 wherein the grate has feet that space the grate from the base.

9. The barbecue of claim 1 wherein the at least one plate includes a solid plate and a grille plate.

10. The barbecue of claim 1 wherein the at least one plate is substantially the same size as an open area defined by the ledge.

11. The barbecue of claim 1 further comprising folding legs that support the barbecue above the ground.

12. The barbecue of claim 11 wherein the legs are removable.

13. The barbecue of claim 1 further comprising a closable vent formed in one of the four walls.

14. The barbecue of claim 13 wherein the vent comprises a plate that slides in a track.

15. The barbecue of claim 13 wherein the vent comprises a rotatable vane.

16. The barbecue of claim 1 further comprising a rotatable spigot for rotisserie cooking.

17. (canceled)
